(19) United States
(12) Patent Application Publication
(10) Pub. No.: US 2007/0004448 A1
(43) Pub. Date: Jan. 4, 2007

(54) Method and apparatus for providing telecommunications backup, exchange system

(75) Inventors: Thomas Stroyls, Croton-on-Hudson, NY (US); Frank Dietze, Nurnberg (DE); Erich Friedrich, Ebermannstadt (DE); Christian Epp, Litzendorf-Schammelsdorf (DE); Bernd Heidner, Pinzberg (DE); Jurgen Krause, Ebermannstadt (DE); Axel Busboom, Unterleinleiter (DE); Wolfgang Peter, Gossweinstein (DE); Jurgen Obernolte, Erlangen (DE)

Correspondence Address: WOOD, HERRON & EVANS, LLP, 2700 CAREW TOWER, 441 VINE STREET, CINCINNATI, OH, 45202, US

(73) Assignee: Vierling North America Inc.

(21) Appl. No.: 11/172,445

(22) Filed: Jun. 30, 2005

(51) Int. Cl. H04M 1/00

(52) U.S. Cl. 455/555

(57) ABSTRACT

A method for providing telecommunication backup to one or a plurality public communication lines 2 providing telecommunication from or to one or a plurality of extensions 5, wherein telecommunication between said extensions and said public communication lines is managed by an exchange 3, provides one or more wireless channels 9, 10 for telecommunication, wherein the exchange routes telecommunication towards said wireless channels when some or all of said public communication lines are not available.

### FIELD OF THE INVENTION

The invention provides a method and apparatus for providing telecommunication backup as well as an exchange system.

### BACKGROUND OF THE INVENTION

Modern life depends to an increasing extent on failure-free and uninterrupted telecommunication. An interrupt in telecommunication services from an entity (e.g. a company, a hospital, an authority, a university, or the like) towards its surrounding may lead to several organizational problems, economical losses or even danger to humans.

A usual setup in an entity, e.g. as mentioned above, is that in the premises of said entity a private branch exchange is installed which exchanges telecommunication between public telephone lines and internal extensions in said premises. The private branch exchange (e.g. a PABX) is used in the customer's premises for handling one or a plurality of public telecommunication lines on the one hand, and a plurality of local extension in the customer's premises, on the other hand. The public telecommunication lines here may be a physical analog telephone line (tip/ring interface) and/or a logical channel, or a plurality of each of them, they may comprise a multi-channel interface, e.g. a T1 trunk, or one or more voice-over-EP interfaces (VoIP).

Many entities protect themselves against a failure of a PABX by using redundant hardware. However, a failure can also occur outside the customer's premises. For example, the public telephone lines may be physically damaged during construction work. Further, the service providers exchange may fail, e.g., due to fire or power outage or natural disasters. Hardware redundancy on the customer's premises does not protect against failures of the latter mentioned kind.

A protection mechanism against physical damage to public telephone lines is to use at least two landline trunks connected to different service providers' exchanges. However, these solutions are typically complex and expensive. Further, point-to-point radio links are known as a backup for a landline failure. Such mechanisms, however, are again expensive and lack flexibility.
WO 2004/039113 describes the use of a fixed-to-mobile gateway in connection with an SIM server.
EP 1 357 732 describes a fixed-to-mobile gateway in connection with a SIM server.
DE 103 41 737 describes a distributed least cost routing between a cell phone and a gateway.
EP 1 432 257 describes a local SIM switching in a gateway for dynamically distributing cell phone channels across a plurality of cell phone nets.
WO 2004/086788 describes cell local SIM switching in a gateway for using up free telecommunication services or for utilizing a plurality of charging modes.
WO 2003/073328 discloses a database for mobile number pointing in a gateway, i.e. for detecting whether a mobile phone number has been transferred to another cell phone provider.
U.S. Pat. No. 4,658,096 describes a system for interfacing a standard telephone set with a radio transceiver.
U.S. Pat. No. 6,035,220 describes a method of determining end of dialing for cellular interface coupling a standard telephone to the cellular network.
U.S. Pat. No. 6,324,410 describes a method and an apparatus for interfacing a cellular fixed wireless terminal to the extension side of a PBX/PABX.

It is the object of the invention to provide a method, and an apparatus, and an exchange system for providing telecommunication backup, which are flexible, reliable, and cost-efficient.

This object is accomplished in accordance with the features of the independent claims. Dependent claims are directed on preferred embodiments of the invention.

### SUMMARY OF THE INVENTION

A method for providing telecommunication backup to one or a plurality of public communication lines providing telecommunication services from or to one or a plurality of extensions comprises the step of managing telecommunication between said extensions and said public communication lines by an exchange. In addition thereto, one or preferably a plurality of wireless channels is provided capable of rendering telecommunication. The exchange routes telecommunication towards said wireless channels, particularly for outbound telecommunication, when some or all of said public communication lines are not available.

The exchange and the public communication lines connected thereto may be chosen and configured such that they are sufficient for ordinary telecommunication under ordinary circumstances, i.e., in the absence of internal and external telecommunication failures. If, vice versa, by such failures telecommunication through the public communication lines is adversely affected (e.g. by making a part or all of the communication lines unavailable because, e.g., a wire was interrupted in the course of construction works outside the premises of an entity), at least a part (e.g. a prioritized part) of the telecommunication may routed through the wireless channels. Such channels are less prone to failure, e.g. cable interruption, fire, flood, and the like.

Wireless channels must be paid for. Often, they come with the offer of pre-paid telecommunication services included e. g. in a basic fee, i.e. an amount of telecommunication that can be used without extra costs. “Prepaid services” in this context may be or include telecommunication services which are periodically, e. g. monthly, offered for no extra costs and which may after a given period, e. g. a month, no longer be available. In these circumstances, the wireless channels actually and primarily provided for backup of public communication lines may also be used under least cost criteria during normal, failure-free conditions in order to consume pre-paid services. Once such pre-paid services are consumed, the routing of ordinary communication through the wireless channels during failure-free conditions may be abandoned or rejected until prepaid services are again available.

The public communication lines may be analog telephone lines or digital lines, particularly logical channels in a multi-channel interface, e.g. a T1 trunk or a voice-over-IP interface (VoIP). The wireless channels may be cell phone communication channels. They may belong to mobile telephony networks, e.g., GSM, CDMA, W-CDMA, and the like.

Managing the wireless channels and the communication through them may be done by a gateway that connects to a usual exchange through a suitable channel, for example one or a plurality of trunks, e.g. a T1 trunk. Then, usual configuration possibilities in the usual exchange are utilized for making the usual exchange properly working with the gateway. The gateway may comprise, among others, an overall control and one or a plurality of interfaces to one or a plurality of wireless channels.

An exchange with usual exchange functions may also be integrated with a gateway to an exchange system. Such an exchange system may have a common control for the usual exchange functions as well as for managing the plurality of wireless channels in view of the applying criteria.

An apparatus according to the invention for providing telecommunication backup for one or a plurality of public communication lines managed by an exchange comprises one or more wireless channel interfaces for wireless telecommunication, one or more interfaces towards the exchange, and messaging means for exchanging control information with the exchange. Said control information exchange comprises sending control information from the apparatus to the exchange for controlling routing of telecommunication from the exchange towards the apparatus.

The apparatus may comprise routing means for routing telecommunication towards one of the wireless channels also in view of least cost criteria, and also in this respect notifying means for exchanging control information with the exchange.

The apparatus may be adapted to or be connectable with a usual, unmodified exchange through a particular interface of said exchange, e.g. a trunk interface, e.g. one or more T1 trunk(s). Thus, the apparatus may be adapted to behave like a T1 trunk towards the exchange. The apparatus may have signaling means for sending control information from the apparatus to the exchange for influencing the operation of the exchange in accordance with the possibilities given there.

With this arrangement a usual exchange may be upgraded by connecting the apparatus to the exchange through one of its interface, particularly an external interface of the exchange, e.g. a T1 trunk interface. The exchange needs not be modified in its hardware setup and may be configured through the usual settings in the exchange to communicate properly with the apparatus.

Said apparatus together with the exchange may form an exchange system, said exchange system being connected to public telecommunication lines, to extension (preferably internal extension) and to wireless channels. In such an exchange system it is also possible to no longer provide the exchange and the apparatus as distinct entities. Rather, they may be commonly constructed having a common control as a joint device rendering the same functions and having the same interfaces.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic view of an overall telecommunication system;

FIG. 2 is a schematic view of the apparatus according to the invention;

FIG. 3 is a flowchart for the operation of the apparatus; and,

FIG. 4 is another flowchart for the operation of the apparatus.

### DETAILED DESCRIPTION OF SPECIFIC EMBODIMENTS

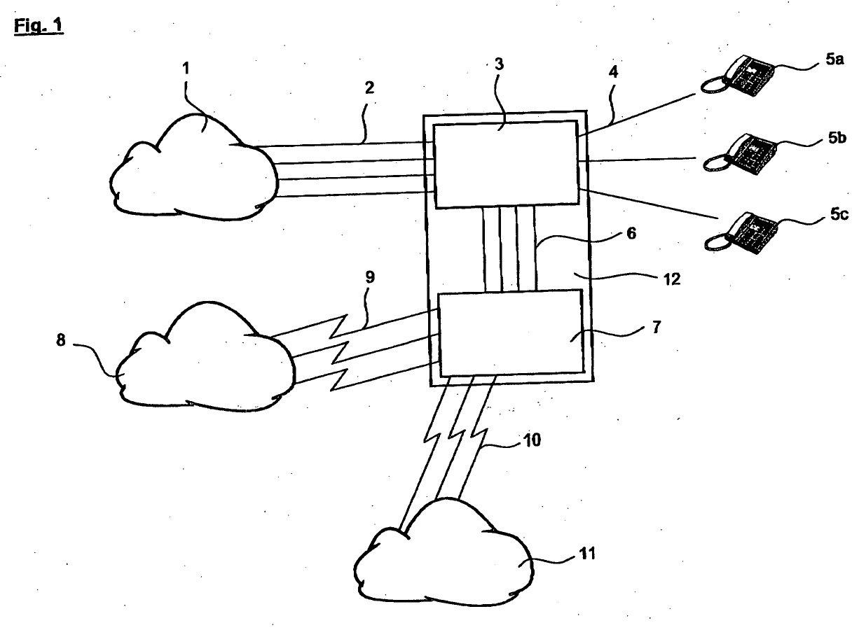

In FIG. 1, reference numeral 3 is an exchange for exchanging telecommunication between public communication lines 2 and extensions 5. The public communication lines 2 lead to a public communication net 1. It may be a wire-based telecommunication net with public exchanges, wires, etc. The public communication lines may be analog or digital. They may be logical channels, e.g., in T1 trunks. Said lines may also be or comprise a voice-over-IP interface. Generally, telecommunication may comprise voice or fax or data communication. The exchange 3 may be a private branch exchange system (PABX) as ordinarily manufactured and distributed. The extensions 5 may be telephones, faxes, modems or digital components, particularly of computers.

The public telecommunication lines 2 and the exchange 3 may be dimensioned and configured such that, in everyday life, they are sufficient for providing telecommunication services to and from the extensions 5 in the desired amount and quality of service.

Reference numeral 7 denotes an apparatus for providing telecommunication backup. It backs up—together with its outgoing connections—the telecommunication reaching and leaving the exchange 3 through the public communication lines 2, particularly in the case that these public communication lines 2 are interrupted, reduced, or show poor quality. The apparatus 7 may be a gateway, and communicates with the exchange 3 through one or more lines or channels 6. Between exchange 3 and gateway 7 one or a plurality of T1 trunks may be provided. The gateway 7 is adapted to connect to one or more wireless channels indicated by reference numerals 9 and 10, with a respective network 8 and 11 being behind them. The wireless channels may be from different providers and/or may be of different technical standards. For example, they may comprise GSM, CDMA, and/or W-CDMA. Preferably, a plurality of wireless channels are provided.

One operation mode of the shown system may be as follows: In usual everyday life, the exchange 3 handles the communication between the extensions 5 and the public telecommunication net 1 via lines 2. Upon the occurrence of a failure in the public communication net 1 or in the public communication lines 2 from the public net towards the exchange 3, the failure is detected by, or notified to, the exchange 3, and in response thereto the exchange 3 begins to route outbound calls (originating in one of the terminals or extensions 5) through the lines 6 towards gateway 7, from where they are further routed through the wireless channels according to predetermined criteria. Thereby outbound communication may be upheld to a given degree through the channels 9 and 10, even if the communication through the public communication lines 2 is disturbed or interrupted.

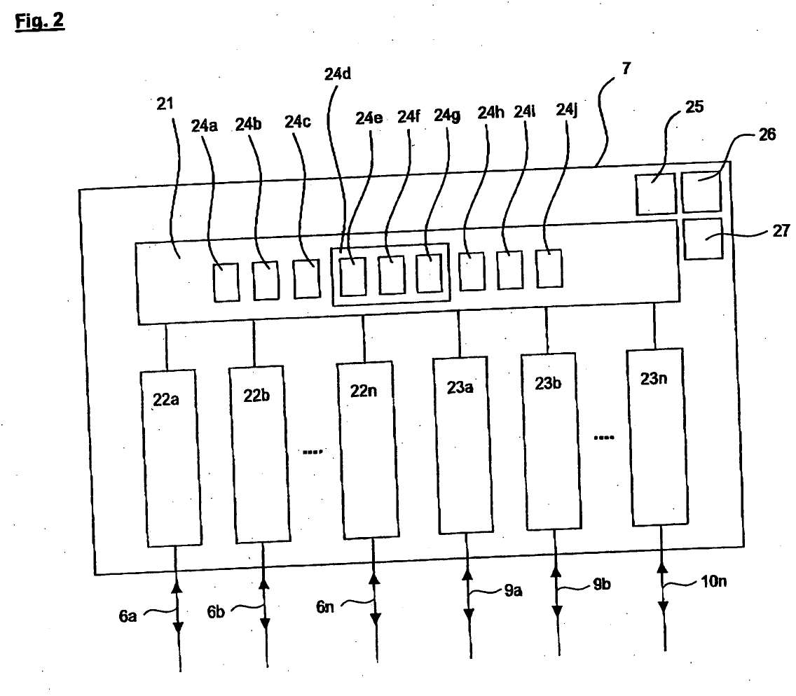

FIG. 2 shows a more detailed structure of the apparatus or gateway 7. Reference numeral 21 symbolizes a general control for controlling the apparatus 7 and the components therein as well as outbound and inbound communication and control signaling. The control may comprise a microprocessor, input and output means 25 for a user (screen, keyboard), a memory 26, a remote control interface 27, and the like. Reference numeral 22 symbolizes interfaces for connecting the apparatus 7 to an exchange through lines 6. One or a plurality of said interfaces and lines may be provided. The lines may be a T1 trunk, and the interfaces may be corresponding interfaces. Therefore, one T1 trunk provides 24 lines for communicating with the exchange. Reference numeral 23 denotes wireless interfaces for communicating through wireless channels 9 and 10.

The general operation of the control 21 is that it receives call setup requests through one of the interfaces 22 connecting to the exchange 3, and decides whether to accept or reject such a setup. If a setup is accepted, the control unit decides which wireless channel and, accordingly, which interface is to be used, sends a call setup to the respective interface and interconnects the respective interface with the respective channel from the exchange. In accordance therewith, a call detail record may be generated and stored. Telecommunication thus routed may be logged. If a setup request is rejected for routing for some reasons, this will be communicated to the exchange 3 so that the request will further be handled in the exchange 3. Together with the rejection, the apparatus 7 may send rejection information to the exchange 3 for informing the exchange 3 about the reason of the rejection. For different reasons of rejections, different rejection information may be sent back to the exchange.

The provision of the wireless channels 9 and 10 is a service that must be bought by the customer. In many cases, this is connected with a certain amount of pre-paid telecommunication services. This has the consequence that through the provision of backup capacity by the gateway 7 the user thereof owns free telecommunication services according to the tariffs applying for the various wireless channels 9 and 10. One feature of the gateway 7 is that it routes outbound telecommunication through one or more of the wireless channels according to least cost criteria. For this, a least-cost-router 24d is provided. It will have the effect of using up free communication services assigned to the back-up wireless channels. Thereafter, the least-cost-router will reject call requests from the extension, unless it is forced to accept them or unless it has free services again. This may involve one or more of the following features:
The gateway has knowledge about the tariff structure applying to the various wireless channels and/or to the involved subscriber identification, such as an involved Subscriber Identification Module (SIM). This may be input to the gateway for each of the individual channels 9 and 10 or SIM through the input means 25.
The gateway 7 keeps records through record-keeping means 24e on the outbound communication, thus rendering a bookkeeping of the communication routed through the various channels and, thus, being able to compare the already used service quantity with possible pre-paid or free service amounts as known by the system. The record-keeping means 24e has means for counting the used telecommunication services for each channel in accordance with the relevant business units (e.g. seconds, units, time slots, etc.) and has further means for resetting the respective counts in accordance with the tariffs applying to the respective channel.

Routing outbound telecommunication through one of the wireless channels 9, 10 by routing control means 24f in accordance with the kept records and comparison results.

Issuing control information through notifying means 24g towards the exchange 3 in order to influence and control the routing of outbound telecommunication from extensions towards gateway 7. This may particularly comprise prompting the exchange to route outbound telecommunication to the gateway 7 as long as free communication services are there, even if no failure in the ordinary telecommunication system (public communication lines 2, public net 1) is present. If the prepaid services are consumed, it may involve interrupting routing of call requests from the exchange 3 to the gateway 7 or rejecting such call requests. Likewise, the notifying means 24g may receive control information from the exchange 3.

Distinguishing whether a call request from the exchange is one in view of least cost criteria (a “voluntary wireless routing”) that may be rejected or a necessary wireless routing that must be accepted because of trouble in the usual telecommunication system.

Error detection in the usual telecommunication environment (i.e. in FIG. 1 public communication net 1, public communication lines 2) may be made automatically in the exchange 3 according to predetermined criteria or may be notified to the exchange. Once a failure is detected in, or notified to, the exchange 3, this may, e.g., have the consequence that in the exchange a prefix is automatically added, prepended or attached to the dialed number from the extensions, this prefix causing in the exchange the respective call setup to be routed to the gateway 7. Likewise, the prefix may also immediately be input by a calling party to force routing via the gateway 7. And further, if the least-cost-router 24d decides that absent failure nevertheless communication can be routed through the gateway 7 and wireless channels, it may send a respective control information through the notifying means 24g to the exchange 3 which again prompts the exchange 3 to add, e.g., a prefix to the dialed telephone number, this prefix causing the call to be routed to the gateway 7. Instead of a prefix, any kind of particular information may be added to a call setup request in order to force routing of a call in the exchange not towards the public communication lines 2, but rather through gateway 7 to the wireless channels 9 and 10.

The apparatus 7 and, particularly, the control 21 thereof may comprise one or more priority means 24b for routing communication originating from a predetermined extension or from a group of predetermined extensions to a particular wireless channel while communication originating from other extensions is not routed to said particular wireless channel. This gives some kind of priority to those extensions assigned to said particular wireless channel, because said channel is kept free for only those extensions assigned to it. For example, one such priority means may allocate the extensions of important executives and managers of a company to one wireless channel. A second priority means may be assigned to particular extensions of the IT department for being able to quickly fix problems by external communication. If a plurality of priority means is provided, they may have a priority order amongst each other, this leading to the highest priority communications being always being connected whenever there is a wireless channel available, the next-lower priority communications always being connected when a wireless channel except that reserved for the highest priority is available, and so on.

The gateway 7 and, particularly, the control 21 thereof, may comprise a suppressing means 24a for suppressing the calling line identification (CLI). This suppressing means suppresses—or replaces—the calling line identification attached to a outbound communication request via the wireless channel. By default, the CLI of a wireless channel is not the number of the calling party, but rather the number under which the wireless channel may be reached. If this wireless channel number is sent as CLI, it may provide wrong information to the called party. Therefore, the suppressing means 24a may suppress such a technically correct, but logically wrong CLI. As far as possible, it may replace this CLI by another value, e.g., by the number of the calling party. Further, the suppression means 24a may keep a table for those extensions which require their extension being shown correctly to the called party. The suppression means will then also comprise the feature that calls voluntarily routed through the gateway 7 and mobile channels (i.e. under least cost routines, not under emergency backup routines) are rejected from being routed through the wireless channels. Rather, the call will go back to the exchange and will be routed from there through conventional channels with correct CLI being shown.

The gateway 7 may reserve one or more wireless channels exclusively for incoming calls and may keep them free from outbound calls and communication. In this respect, it may also comprise changing means 24c for changing the wireless channel reserved for inbound traffic such that once in a while a channel reserved for inbound traffic is used for outbound traffic, and vice versa. The reason therefor is that, if free telecommunication services are allocated to an channel 3 used only for inbound communication, these services might not be consumed by inbound traffic only. Therefore, in order to consume free telecommunication services by outbound communication, channels reserved for inbound communication are changed from time to time or under predetermined criteria.

The apparatus 7 may comprise an identifying means 24h for identifying particular outbound call requests from the exchange 3. Such calls are not rejected by the gateway 7 from routing via one of the wireless channels (except, of course, all channels are occupied or perhaps kept free for priority reasons). However, rejections under other criteria (e.g. free telecommunication services being used up, CLI must be displayed properly) will no longer be made. Such an identification may be used when the usual telecommunication structure is disturbed. A particular identification may then be added to the outbound calls routed from the exchange to the gateway 7. The gateway 7 recognizes from the attached information, e.g. a dialing prefix, that such requests must not be rejected, unless they can technically be routed. But as already said, the priority means 24b may be more powerful than the forced routing accomplished through a particular information recognized by the identification means 24h.

The above mentioned differing rejection information for different reasons of rejections of call requests by the gateway 7 may comprise so-called “cause values” CVn for at least one or more of the following situations:

CV1: . . .

CV2: No mobile net available

CV3: No SIM or SIM error

CV4: No channel available in external net

CV5: No channel (with suitable priority) available in the gateway

CV6: CLI must be shown properly

CV7: No free services available

CV8: . . .

The exchange 3 may be configured to evaluate the rejection information and to take appropriate subsequent action, e. g. routing a call through the public communication lines 2. Under some rejection information, an alarm may be generated, service may be requested or the like. The gateway 7 sends such information to the exchange 3 through messaging means 24i.

Further, the gateway 7, and particularly the control 21 thereof, may comprise an inbound routing means 24j. It may be configured such that it routes through the exchange particular wireless channels to particular extensions. This can be accomplished by examining the number of the called wireless terminals, and particularly looking whether an extension on the user's premises is allocated to said wireless channel. If yes, the incoming call is routed to said extension. Then, such an allocated wireless channel behaves just like a cell phone owned by the person to which the routed extension belongs. In this case, if outgoing calls are routed through such a wireless channel with incoming extension allocation, the CLI may be suppressed in response to the allocation of the incoming calls to an extension.

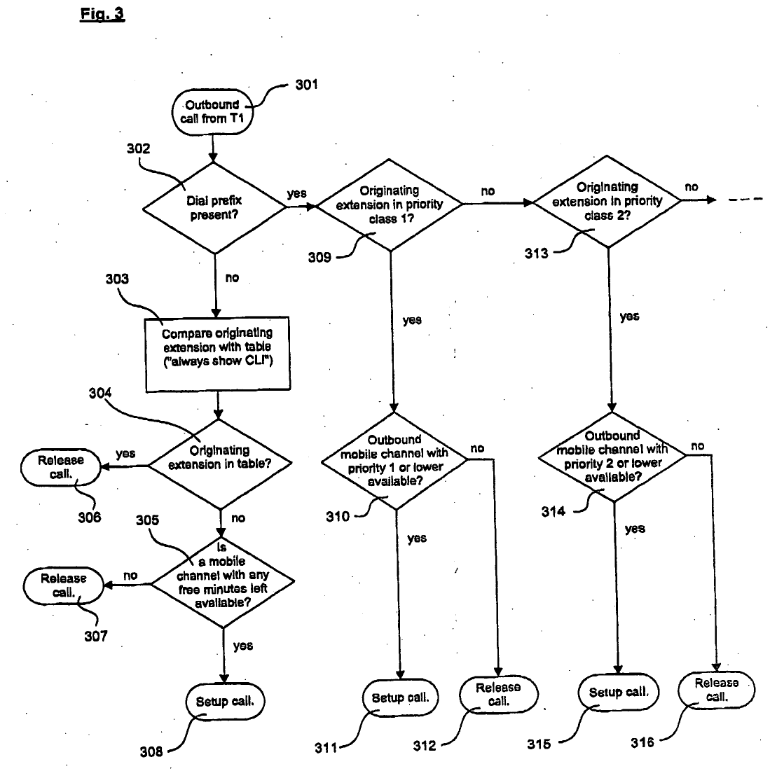

FIG. 3 shows a flowchart of processing an outbound call request or communication request reaching the gateway 7 from the exchange 3. It starts with a step 301 in which an outbound call request is received in gateway 7 from exchange 3. In step 302 it is, first, checked whether a particular information, e.g. a dial prefix, is present which would force the gateway 7 to accept the call request for routing. If no, in step 303 it is checked whether the call request comes from an extension which wants its calling line identification always properly be displayed. If the comparison in step 303 or 304 shows that the extension wants its CLI properly be displayed, this means that in step 306 the call request is rejected, so that the call goes back to the exchange where it is routed again to an ordinary line with proper CLI being displayed. Next, if in step 304 it is decided “no”, in step 305 it is checked whether in one of the available channels free telecommunication services are available. If yes, the call request is finally accepted, routed to a suitable terminal, and the call is established. If no, in step 307 the call is rejected and returns to the exchange for further routing there.

The decisions and interrogations described so far in FIG. 3 all apply to the case that the gateway 7 is not forced (by user demands or because of failure in the ordinary telecommunication environment by means of the particular information, e.g., the dial prefix checked in step 302) to accept the call request. When in these cases in steps 306 or 307 a call request is rejected, said call request will further be handled by the exchange 3. There, a rehunt prevention mechanism must be established at least such that the exchange does not try again to route the call request to the gateway 7. This can be prompted by supplying suitable rejection information from the gateway 7 to the exchange 3, and configuring the exchange 3 such that, upon receiving the information, a rehunt to the gateway is prevented.

If, however, the gateway 7 is forced to accept the call request (by a particular information attached to the call request, e.g., a prefix, checked in step 302), the priority status of the calling party is checked in step 309. If it is class 1 priority, it is checked in step 310 whether a mobile channel with class 1 priority or lower is available. If yes, the requested call is set up. If no, the requested call must be rejected, because no channels are available. If in step 309 the decision is that the calling party does not enjoy class 1 priority, it is next decided in step 313 whether a class 2 priority is given. If yes, it is checked in step 314 whether an outbound mobile channel with said priority class 2 or lower is available. Again, if yes, the requested call is set up in step 315. If no channel with priority 2 or lower is available, the call request must be rejected due to unavailability of suitable channels. If, in step 313, it is decided that the calling party does not enjoy priority class 2, the priority interrogation is continued in the same way as described so far. Finally, for a not at all prioritized calling party the gateway will check as to the availability of a normal wireless channel and will set up the call if such a normal is channel is available. And if it is not available, again the call request must be rejected.

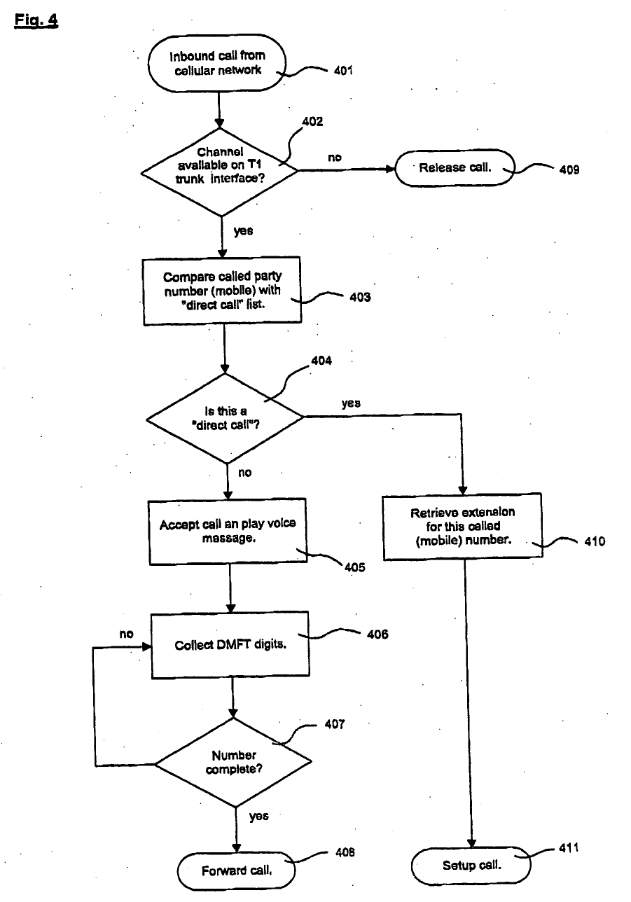

FIG. 4 shows a flowchart for the processing of an call inbound from a cellular network. The caller must know the telephone number of the respective channel. If it is called, the gateway will first check whether a channel towards the exchange 3 through one of the lines 6 is available. If no, the call must be rejected, because it cannot be routed to the exchange (step 409). If a channel towards the exchange 3 is available, it is checked whether the called channel is allocated to a particular extension (step 403). If such an allocation is found, the inbound call is transferred to the exchange with the information that it is to be routed to the extension to which the called wireless channel is allocated (retrieval of extension in step 410, call setup in step 411). If the called wireless channel is not mapped to a particular extension, the call may be accepted and a voice message may be played, e.g., prompting the calling party to input the extension of the desired party. In steps 406 and 407 these extension digits are collected and checked as to completeness. If they are complete, the extension number is forwarded together with the call request to the exchange for further processing there.

Alternatively, calls not being mapped on a particular extension calls may be routed through the exchange to a switchboard or operator for further routing there.

Further, one of the provided wireless channels may have an external priority with prioritized access to the network facilities and network channels. This will be useful, particularly in disaster scenarios where telephone networks are usually overloaded. In such situations, a wireless priority service (WPS) has external prioritized access over usual subscriptions. Internally, such a channel may be treated according to one of the above mentioned options.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for providing telecommunication backup to one or a plurality of public communication lines providing telecommunication from or to one or a plurality of extensions, wherein telecommunication between said extensions and said public communication lines is managed by an exchange,
characterized in that
one or a plurality of wireless channels for telecommunication are provided, wherein the exchange routes telecommunication towards said wireless channels when some or all of said public communication lines are not available.

2. The method of claim 1, wherein one or more of said wireless channels are mobile telephony channels.

3. The method of claim 1 or 2, wherein the wireless channels are connected through a gateway, said gateway communicating with said exchange.

4. The method of one or more of the preceding claims, wherein said non-availability is automatically detected and/or can be indicated from external.

5. The method of one or more of the preceding claims, characterized in that for calls going out via a wireless channel the calling line identification is suppressed or replaced.

6. The method according to one or more of the preceding method claims, wherein at least one of the wireless channels is reserved for a predetermined group of one or more of said extensions.

7. The method according to claim 3, wherein the exchange sends a communication setup-request to the gateway, the gateway decides whether the communication can be routed over a wireless channel, and if yes, sets up the call through the wireless channel.

8. The method according to claim 7, wherein when the gateway decides that the communication cannot be routed over a wireless channel, it rejects the request by sending a related information to the exchange, the information preferably being particular for the reason of rejection.

9. The method of one or more of the preceding claims, characterized in that at least one of the wireless channels is reserved for incoming or for outgoing telecommunication, wherein preferably amongst a plurality of wireless channels said wireless channel reserved for incoming telecommunication is changed from time to time.

10. The method according to one of the preceding claims, wherein a plurality of wireless channels are provided, said channels being provided by at least two different service providers and/or being configured according to at least two different technical standards.

11. The method according to one of the preceding claims, wherein the exchange routes calls between said extensions and said public communication lines, and routes calls for the wireless channels towards a gateway, said gateway interfacing with said exchange and with said wireless channels.

12. The method of one or more of the preceding claims, wherein the exchange routes telecommunication towards said wireless channels also in view of least-cost-criteria.

13. The method according to claim 11 and 12, wherein the gateway keeps records of the communications routed via a wireless channel and controls routing of calls via the wireless channels in accordance with said records, said control being preferably accomplished by accepting or rejecting a communication request from the exchange.

14. The method according to claim 13, wherein the gateway rejects outgoing calls routed from the exchange to the gateway in accordance with said records.

15. The method according to claim 14, wherein the gateway, upon rejection, issues predefined rejection information to the exchange.

16. The method according to claim 14 or 15, wherein calls comprising a particular identification are in any case accepted for routing through the gateway.

17. The method according to one or more of the preceding method claims, wherein calls coming in via a particular wireless channel are routed to a particular extension.

18. The method according to claim 16, wherein the particular identification is set by a user or by the exchange.

19. The method according to one of the claims, wherein the exchange communicates with the gateway through at least one trunk line and communicates with the public communication lines through at least another trunk line.

20. The method according to claim 15 and 19, wherein, after rejection, the exchange routes a call to a line in another trunk line.

21. An apparatus (7) for providing telecommunication backup to one or a plurality public communication lines (2) for providing telecommunication from or to one or a plurality of extensions (5), wherein telecommunication between said extensions (5) and said telephone lines (2) is managed by an exchange (3),
characterized in comprising
one or more wireless channel interfaces (23) for wireless telecommunication, one or more interfaces (22) towards the exchange and messaging means (24g) for providing control information towards the exchange.

22. The apparatus of claim 21, wherein one or more of said wireless channel interfaces are mobile telephony interfaces.

23. The apparatus of one or more of the claims 21 and 22, comprising means (24a) for suppressing or replacing the calling line identification for calls going out via a wireless channel interface.

23. The apparatus of claim 21, comprising means (24b) for routing calls from a predetermined group of one or more of said extensions to a particular wireless channel while calls from other extensions are not routed to said particular wireless channel.

24. The apparatus according to one or more of the preceding apparatus claims, characterized in comprising means (24c) for reserving at least one of the wireless channels for incoming or for outgoing telecommunication.

25. The apparatus according to claim 25, comprising means (24c) for changing said wireless channel reserved for incoming telecommunication from time to time.

26. The apparatus according to one or more of the preceding apparatus claims, wherein a plurality of wireless channels (9a, 9b . . . 10n) are provided, said channels being provided by at least two different service providers and/or having at least two different technical standards.

27. The apparatus of one or more of the preceding apparatus claims, comprising means (24d) for routing telecommunication towards said wireless channels also in view of least-cost-criteria

28. The apparatus according to claim 23, comprising means (24e) for keeping records of the communications routed via a wireless channel, and means (24f) for controlling routing of calls via the wireless channels in accordance with said records.

29. The apparatus according to claim 28, wherein the routing control means rejects outgoing calls routed from the exchange to the apparatus in accordance with said records.

30. The apparatus according to claim 29, comprising means (24g) for issuing, upon rejection, predefined information to the exchange.

31. The apparatus according to claim 29 or 30, comprising means (24h) for identifying call requests from the exchange comprising a particular identification, said identified call requests being in any case accepted for routing through the apparatus.

32. The apparatus according to one or more of the preceding apparatus claims, comprising at least one trunk line interface towards said exchange.

33. An exchange system, particularly for carrying out the method according to one or more of the preceding method claims, the system comprising an apparatus (7) according to one or more of the preceding apparatus claims and an exchange (3), said exchange being in communication with a plurality of extensions, with said apparatus and with a plurality of public communication lines.
